(19) United States
(12) Patent Application Publication
(10) Pub. No.: US 2016/0368459 A1
(43) Pub. Date: Dec. 22, 2016

(54) WINDSCREEN WIPER BLADE INCORPORATING A HEAT-CONDUCTING MATERIAL

(71) Applicant: Valeo Systèmes d'Essuyage, Le Mesnil Saint Denis (FR)

(72) Inventors: Gérald Caillot, Cernay La Ville (FR); Vincent Izabel, Chilly Mazarin (FR); Jean-Michel Jarasson, Le Mesnil Saint Denis (FR); Stephane Boursier, Tokyo (JP)

(73) Assignee: Valeo Systèmes d'Essuyage, Le Mesnil Saint Denis (FR)

(21) Appl. No.: 15/183,849

(22) Filed: Jun. 16, 2016

(30) Foreign Application Priority Data
Jun. 16, 2015 (FR) 1555477

(51) Int. Cl. B60S 1/38; B60S 1/04

(52) U.S. Cl. CPC B60S 1/3803; B60S 1/0408

(57) ABSTRACT

The invention relates to a wiper blade (42) for a windscreen wiper, which comprises at least one rib (40) and a lower lip (46) extending from the rib (40) and intended to come into contact with a surface (22) requiring wiping, characterised in that at least one part of the blade (42) comprises a metal heat-conducting material (48), and/or is covered with a metal heat-conducting material.

The invention relates to a windscreen wiper blade, in particular for a motor vehicle.

The invention more particularly relates to a wiper blade for a windscreen wiper, comprising at least an upper rib and a lower lip extending from the rib which is intended to come into contact with the surface which has to be wiped, for example a motor vehicle windscreen.

Such blades are fitted to heated windscreen wipers in a known way. Such a windscreen wiper comprises at least one main body which receives at least one heating element extending substantially along the length of the wiper, and a wiper blade located close to the heating element, the said blade occupying an orientation substantially perpendicular to the surface which has to be wiped. The blade incorporates an upper rib by which it is fixed to the wiper and a lower lip extending from the upper rib which is intended to come into contact with the surface which has to be wiped.

Many examples of windscreen wipers comprising heating means are known.

Document WO/2011/098261 describes for example a windscreen wiper comprising a blade incorporating a stiffener, which is consequently inserted into the blade and heating elements arranged in contact with the stiffener, through which the wiper blade can be heated. In such a device the heating means in contact with the stiffener thus transmit the heat which they emit directly to the blade in such a way that the blade is heated relatively rapidly.

Depending upon how it is mounted in a windscreen wiper, a wiper blade is not always located immediately close to the heating element, which sometimes gives rise to problems of transmission of the heat emitted by the said heating element to the blade.

In accordance with a known arrangement there has been provided a windscreen wiper incorporating an aerodynamic deflector which receives a main body, this body receiving at least one stiffener in contact with which there is a heating element located in an upper part within the deflector, and the rib of the wiper blade is located in the lower part. The blade is thus not placed directly in contact with the stiffener. The rib of the blade is in fact held in a matching groove formed in the main body that is separate from that receiving the stiffener and the heating element. In such a device the heat emitted by the heating means thus passes through the main body before reaching the rib of the blade.

Now in this configuration the dimensions of the contact points between the rib of the blade and the groove in the main body are relatively small, so that conduction of heat from the main body to the blade proves difficult.

Furthermore, the material of the blade, which is normally constructed of an elastomer or rubber, has very low conductivity.

Thus under winter conditions in freezing weather such a windscreen wiper suffers a high risk of being stuck to the windscreen. Sticking is harmful to the service life of a windscreen wiper blade, because operation of a windscreen wiper stuck to a frosty or frozen windscreen leads to tearing of the end of the lip, whose performance is thus rapidly degraded and becomes unsuitable for satisfactory wiping.

In addition to this, such a blade generally incorporates a narrow zone of small width between the rib and the lip, also known by the name of hinge, which is intended to impart flexibility to the lip in relation to the rib. Ice or snow can become lodged in this narrow zone, and this may disturb satisfactory pivoting of the said hinge and result in wiping defects.

In order to accelerate heating of a blade, and thus remedy this disadvantage, one solution comprises improving the thermal conductivity of the blade, substantially from the rib to the lip. Heating the blade also makes it possible to melt the snow or ice at the hinge and as a consequence avoid the defects of cold wiping.

With this object the invention comprises a wiper blade of the type described above, characterised in that at least part of the blade comprises a metal heat-conducting material and/or is covered with a metal heat-conducting material.

According to other characteristics of the invention:
at least the rib comprises the said metal heat-conducting material and/or is covered with the said metal heat-conducting material,
the lip comprises the said metal heat-conducting material and/or is covered by the said metal heat-conducting material,
the metal heat-conducting material has a thermal conductivity in excess of 100 W/mK,
the heat-conducting material comprises copper, aluminium or silver,
an elastomer material of the blade incorporates the metal heat-conducting material,
the blade comprises a coating of metal heat-conducting material covering the said blade,
the metal heat-conducting material is a deposit of a composition of metal particles in solution,
sides of the lip are coated with the metal heat-conducting material and the said sides are covered with a material protecting the said metal heat-conducting material,
the blade incorporates a metal insert of metal heat-conducting material incorporated in the said blade,
the metal insert comprises at least a first part which extends to the contact with the free extremity surface of the rib and a second part which extends within the thickness of the blade,
the second part extends in accordance with the general orientation of the blade, substantially along a median line of the blade, in the direction of one extremity of the lip,
the second part of the metal insert extends at least partly within the lip.

The invention also relates to a process for manufacturing a wiper blade of the type previously described, characterised in that a thermoconducting composition comprising a metal powder dispersed in solution in a liquid vector and a gelling agent is prepared, and then at least part of the wiper blade is coated with the said composition, or the said at least part of the blade is immersed in the said composition, or the said composition is sprayed onto the said at least part of the wiper blade, and in that the said wiper blade is then dried.

In accordance with other characteristics of this process:
the blade is dried at ambient temperature, or, to accelerate drying, under a flow of hot drying air.
the coating, immersion or spraying stage is carried out so as to coat a pair comprising two wiper blades joined by their lips, the process also comprising a stage of cutting the pair at the junction between the two lips in order to obtain two blades.

The invention also relates to another process for the manufacture of a wiper blade of the type described previously, characterised in that an elastomer material of the blade is extruded or injected around a metal insert of heat-conducting material.

The invention finally relates to a windscreen wiper, in particular for a motor vehicle, comprising at least one main body which receives at least one heating element which extends substantially over the length of the wiper, and a wiper blade of the type described previously, the rib of which is housed in the said main body.

Other features and advantages of the invention will be apparent from a reading of the following detailed description, for an understanding of which reference should be made to the appended drawings, in which:

FIG. 1 is a view in transverse cross-section of a windscreen wiper according to a prior state of the art comprising a blade according to the invention;

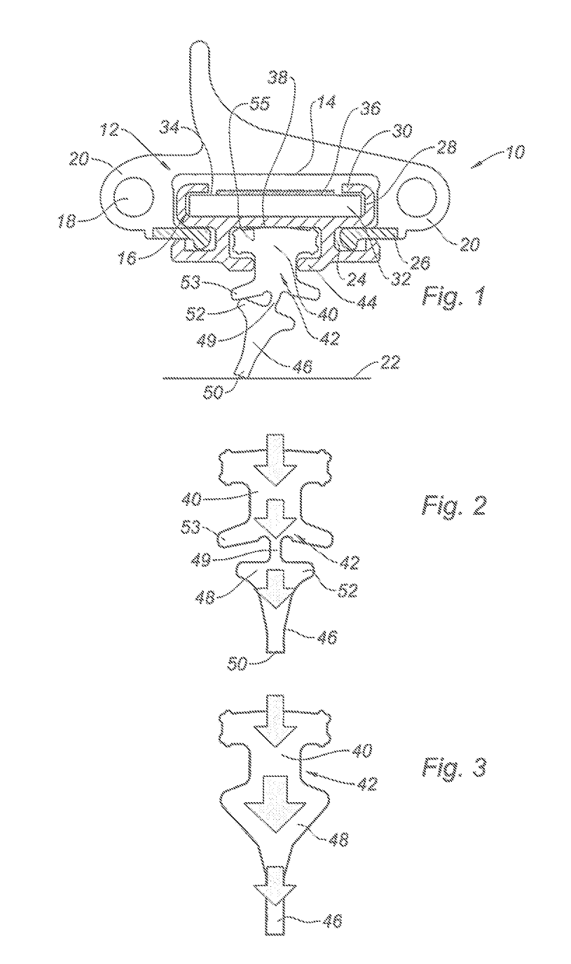

FIGS. 2 and 3 are views in transverse cross-section of two variants of a first embodiment of the blade;

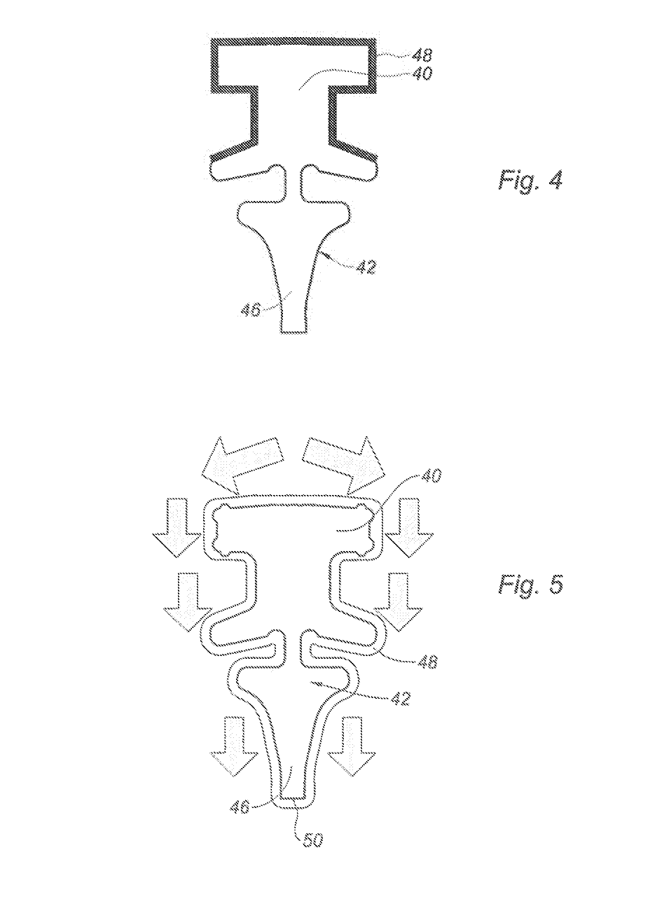

FIGS. 4 and 5 are views in transverse cross-section of first and second variants of a second embodiment of the blade;

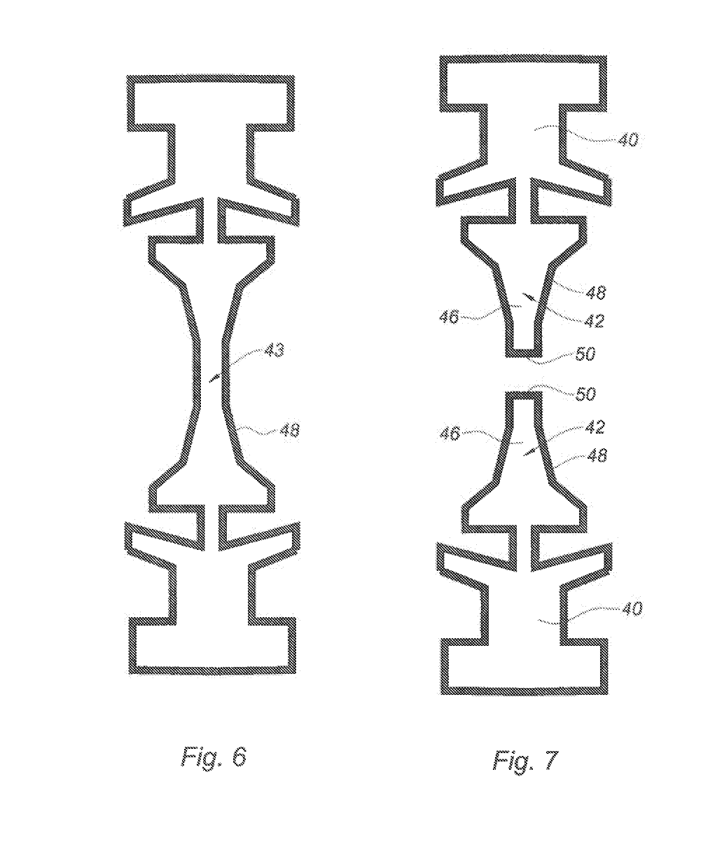

FIGS. 6 and 7 are views in transverse cross-section of stages in a process for obtaining a third variant of the second embodiment of the blade;

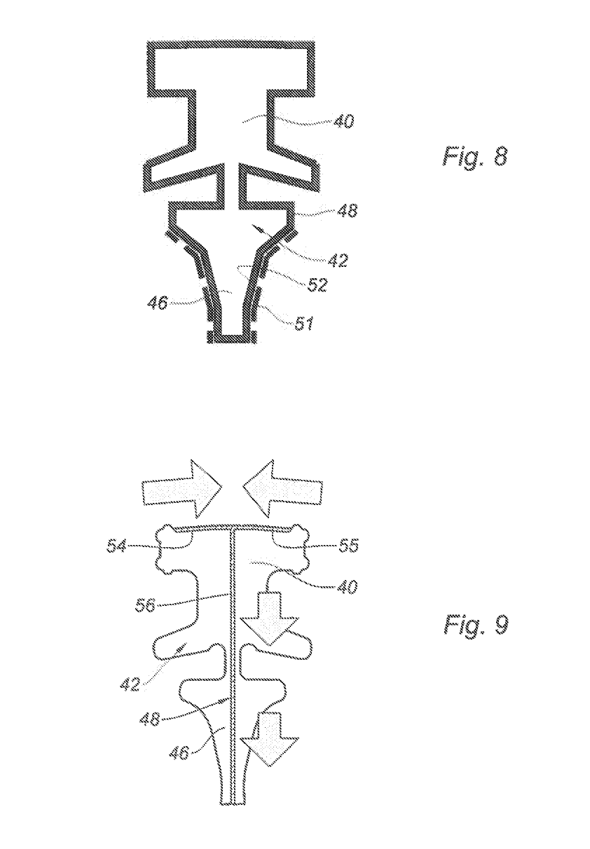

FIG. 8 is a view in transverse cross-section of a fourth variant of a second embodiment of the blade; and

FIG. 9 is a view in transverse cross-section of a third embodiment of the blade.

In the description which follows, identical reference numbers designate identical parts or parts having similar functions.

It should be noted that the figures describe the invention in detail for implementation of the invention, but the said figures could of course be understood to serve to better define the invention if appropriate.

Furthermore, in the following description the terms longitudinal, lateral or vertical refer to the orientation of the windscreen wiper or the operating arm according to the invention. The longitudinal direction corresponds to the principal axis of the wiper or arm in which it extends, whereas the directions referred to as being upper or lower correspond to orientations perpendicular to the plane of the windscreen over which the wiper blade sweeps, the term lower incorporating the plane of the windscreen. Finally the lateral orientations correspond to straight lines crossing the longitudinal direction and the vertical direction.

By way of example FIG. 1 illustrates a windscreen wiper 10, in particular for a motor vehicle, constructed in a manner known in the state of the art. Wiper 10 is intended to sweep a windscreen 22. Wiper 10 essentially comprises an aerodynamic deflector 12, also known by the English term “spoiler”, which receives in the housing 14 a main body 16 of wiper 10. Aerodynamic deflector 12 further comprises for example a pair of conduits 18 located at the transverse extremities 20 of deflector 12, which are intended to allow a washing liquid to be delivered so that it can be sprayed onto windscreen 22 in the immediate vicinity of wiper 10 through nozzles (not shown) pierced in said conduits 18.

It will be understood that wiper 10 illustrated in FIG. 1 does not restrict the invention. In particular, deflector 12 of wiper 10 may not incorporate conduits such as conduits 18, or may as a variant incorporate an attached external spray unit which is not incorporated in deflector 12 of wiper 10.

Main body 16 comprises two lateral grooves 24 having an axial orientation and open towards the exterior of the main body, into which nest the inner wings 26 of deflector 12 to ensure that main body 16 is attached to deflector 12.

Main body 16 has an upper housing 28, bounded by lateral wings 30, which receives at least one rib 32 on an upper surface 34 of which there lies a heating element 36, which for example comprises a resistance-heating film. Heating element 36 extends substantially over the length of wiper 10.

Wiper 10 illustrated by way of example in FIG. 1 includes only one rib 22, but it will be understood that it might incorporate two or several ribs, at least one of which receives a heating element 36 without changing the nature of the invention.

Main body 16 comprises a lower housing 38 which receives an upper rib 40 of a wiper blade 42. Rib 40 is held in housing 38 by the lower wings 44 of housing 38. In the context of its use, wiper blade 42 is orientated substantially perpendicular to or slightly inclined to the surface which has to be wiped, in this case windscreen 22. It comprises a lower lip 46 extending from upper rib 40 and is intended to come into contact with in this case windscreen 22.

In the configuration described above, the part of blade 42 which extends closest to heating element 36 is rib 40, and as a consequence it is this part of blade 42 which is most capable of receiving the heat originating from heating element 36.

Also, in accordance with the invention, in order to improve the heating of blade 42, at least one part of blade 42 comprises a metal heat-conducting material 48 and/or is covered by the said metal heat-conducting material 43.

In the configuration illustrated in the figures, it is therefore at least rib 40 of blade 42 which comprises heat-conducting material 48 and/or is covered therewith. It will be understood that if heating element 36 is implanted in a different way dose to another part of blade 42, it will be at least this other part which might include heat-conducting material 48 or be covered therewith.

This configuration has for example been illustrated in FIG. 4, which illustrates a blade 42 in which only rib 40 incorporates heat-conducting material 48. The detail of metal heat-conducting material 48 in this embodiment will be described later in the remainder of this description.

However, in the preferred embodiments of the invention, lip 46 also comprises said metal heat-conducting material 48 and/or is covered therewith. In this way the thermal conductivity of the whole of blade 42 is improved, as a result of which heat can be propagated right to the extremity of lip 46 and its detachment from a frozen windscreen 22 in very cold weather can be accelerated. This configuration has for example been illustrated in FIG. 5, which shows a blade 42 whose rib 40 and lip 46 comprise heat-conducting material 48. The detail of metal heat-conducting material 48 in this embodiment will be described below in the remainder of this description.

Preferably metal heat-conducting material 48 has a thermal conductivity in excess of 100 W/mK.

For example the heat-conducting material comprises copper, aluminium or silver.

In accordance with a first embodiment of blade 42 illustrated in FIGS. 2 and 3 an elastomer material of blade 42 comprises metal heat-conducting material 48. The metal heat-conducting material is incorporated into the elastomer material before it is injected or extruded in such a way as to ensure that it is present throughout the body of blade 42 and is uniformly distributed within the elastomer material.

In a first variant of this first embodiment, illustrated in FIG. 2, blade 42 comprises narrow zone 49 of small width between rib 42 and lip 46, also known as a hinge, which is intended to impart flexibility to lip 46 in relation to rib 40, in a known way.

It is in fact known that in order to obtain maximum wiping quality it is essential that the inclination of free extremity 50 of lip 46, in relation to the windscreen, be held close to an optimum given value, as illustrated in FIG. 1. This is why blade 42 incorporates a hinge 49 which allows lip 46 to be articulated in relation to rib 40, lip 46 comprising in its upper part wings 52 which are systematically wedged against the lower wings 53 of rib 40 when wiper 10 is moved laterally in contact with windscreen 22. The wedging action takes place alternately on one side or the other of blade 42 depending upon the direction in which wiper 10 is effectively being moved, reversal of the direction of sweeping causing tilting of wiper blade 42 and its lip 46 from one wedged position to the other.

In very cold weather, in order to prevent rapid deterioration of the elastomer material of blade 42, it is known that this hinge 49 can be dispensed with, as illustrated in FIG. 3. This configuration makes it possible to provide a larger cross-section for the passage of heat at the point where the hinge is conventionally located, and thus to encourage the passage of heat to the extremity of lip 46.

According to a second embodiment of the invention illustrated in FIGS. 4 to 8, blade 42 comprises a coating of metal heat-conducting material 48 which covers blade 42.

According to a first variant of this second embodiment illustrated in FIG. 4, only rib 40 is coated with material 48. This configuration makes it possible for the heat originating from heating element 36 to be efficiently collected.

In accordance with a second variant of this second embodiment illustrated in FIG. 5, rib 40 and lip 46 are coated with material 48. This configuration makes it possible for the heat originating from heating element 36 to be efficiently collected and delivered to lip 46.

The heat-conducting material may or may not cover extremity 50 of lip 46 which is in contact with windscreen 22. For example, in the second variant of the second embodiment illustrated in FIG. 5, extremity 50 of lip 46, like the rest of lip 46, is covered with heat-conducting coating 48. According to a third variant of the second embodiment illustrated in FIGS. 6 and 7 extremity 50 does not have this heat-conducting coating 46, for considerations relating to the effectiveness with which windscreen 22 is wiped.

According to a third variant of the second embodiment of blade 42 illustrated in FIG. 6, thermoconducting material 46 coats the lateral sides 52 of lip 46 and said sides 52 are covered with a material 51 which protects said second heat-conducting material 48. Through this configuration heat-conducting coating 48 can be protected from external attack, but the window of the vehicle can also be protected against attack by the metal heat-conducting material, which could for example give rise to the appearance of scratches on the said glass.

In all the variants of the second embodiment, a composition comprising a metal powder dispersed in solution in a vector liquid, and a gelling agent, is for example used to produce heat-conducting coating 48. The coating in the liquid phase is first deposited on the parts of blade 42 which it is intended to treat. For example wiper blade 42 can be coated or immersed in the composition, or again the composition can be sprayed onto blade 42.

The coating is then dried. Drying takes place in the open air or as a variant under a flow of hot drying air, to accelerate drying.

Different manufacturing processes are used depending upon whether it is desired that extremity 50 of blade 42 be provided with heat-conducting coating 48 or not.

If it is desired to obtain a blade 42 whose extremity 50 is covered with heat-conducting material, as illustrated in FIG. 5, blade 42 is merely coated with the composition, as explained previously, and then dried.

Conversely, if it is desired to obtain a blade 42 whose extremity 50 has no heat-conducting material, as illustrated in FIG. 7, a composition of the type described previously is used in order to be deposited not on a single blade 42, but on a pair 43 as illustrated in FIG. 6, which comprises two wiper blades 42 joined by their lips 46. Pair 43 is made in one piece through injection moulding.

Pair 43 is coated with the composition, or immersed in the composition, or covered by spraying, as illustrated in FIG. 6. Pair 43 is then dried, and pair 43 is then cut at the junction between two lips 46 to obtain two blades 42 which have no coating of the second material at the extremities 50 of their lips 46, as illustrated in FIG. 7. Cutting is preferably effected by means of a laser cutting process, to ensure accuracy of cutting.

However, cutting may also be effected through a more conventional mechanical cutting process, such as a cutting process using a shearing blade.

In accordance with a third embodiment illustrated in FIG. 9, blade 42 comprises a metal insert of heat-conducting material 48 incorporated into said blade 42.

As illustrated in FIG. 9, metal insert 48 of heat-conducting material comprises at least a first part 54 extending as far as contacting a free extremity surface 55 of rib 40 and at least a second part 56, preferably of one piece with first part 54 in order to favour the conduction of heat, which extends within the thickness of blade 42. First part 54 makes it possible to collect heat close to heating element 36, which is located within main body 16 of the wiper.

Second part 56 extends along the general orientation of blade 42, substantially following a median line of blade 42 in the direction of one extremity of lip 46 in order to deliver heat to the lower parts of blade 42 and to do so uniformly throughout the thickness of blade 42.

It will be understood that, preferably, second part 56 of the metal element extends at least partly within lip 46 in order to deliver the heat as close as possible to extremity 50 of lip 46.

Such a blade 42 is obtained by a manufacturing process during the course of which an elastomer material of blade 42 is extruded or injection moulded around metal insert 48. This process makes it possible to ensure satisfactory adhesion of metal insert 48 in contact with the elastomer material.

Of course, in the case where second part 56 extends within lip 46, care will be taken to ensure that this second part 56 has bending characteristics which are suitable for matching the tilting of lip 46, as explained previously.

The invention makes it possible to improve the transmission of heat within a blade 42 of a windscreen wiper 10 in an effective way.

Such a blade 42 can be advantageously fitted to a windscreen wiper 10 of the type described previously, and thus increase its heating performance substantially.

1. A wiper blade for a windscreen wiper, comprising:
at least one upper rib; and
one lower lip extending from the rib and intended to come into contact with a surface which has to be wiped,
wherein at least part of the blade comprises a metal heat-conducting material and/or is covered with a metal heat-conducting material.

2. The wiper blade according to claim 1, wherein at least the rib comprises the said metal heat-conducting material and/or is covered with the said metal heat-conducting material.

3. The wiper blade according to claim 1, wherein the lip comprises the metal heat-conducting material and/or is covered with the said metal heat-conducting material.

4. The wiper blade according to claim 1, wherein the metal heat-conducting material has a thermal conductivity in excess of 100 W/mK.

5. The wiper blade according to claim 1, wherein the heat-conducting material comprises copper, aluminium or silver.

6. The wiper blade according to claim 1, an elastomer material of the blade comprises the metal heat-conducting material.

7. The wiper blade according to claim 1, further comprising a coating of metal heat-conducting material covering the blade.

8. The wiper blade according to claim 7, wherein the metal heat-conducting material is a deposit of a composition of metal particles in solution.

9. The wiper blade according to claim 1, wherein the lateral sides of the lip are coated with metal heat-conducting material and the sides are covered with a material protecting the said metal heat-conducting material.

10. The wiper blade according to claim 1, further comprising a metal insert of metal heat-conducting material incorporated into the said blade.

11. The wiper blade according to claim 10, wherein the metal insert comprises at least a first part which extends to the contact of a free extremity surface of the rib and a second part which extends within the thickness of the blade.

12. The wiper blade according to claim 11, wherein the second part extends in accordance with the general orientation of the blade, substantially following a median line of the blade in the direction of one extremity of the lip.

13. The wiper blade according to claim 11, wherein the second part of the metal insert extends at least partly within the lip.

14. A process for manufacturing a wiper blade according to claim 1, wherein a heat-conducting composition comprising a metal powder dispersed in solution in a vector liquid and a gelling agent is prepared, and at least part of the wiper blade is coated with the said composition, or the said at least one part of the blade is immersed in the said composition, or the composition is sprayed onto the said at least one part of the wiper blade, after which the said wiper blade is dried.

15. The process according to claim 14, wherein the blade is dried at ambient temperature or under a flow of hot drying air.

16. The process according to claim 14, wherein a stage of coating, immersion or spraying is carried out in order to coat a pair comprising two wiper blades joined by their lips, the process further comprising a stage of cutting the pair at the junction between the two lips in order to obtain two blades.

17. The process for the manufacture of a wiper blade according to claim 14, wherein an elastomer material of the blade is extruded or injection moulded around a metal insert of heat-conducting material.

18. A windscreen wiper for a motor vehicle, comprising:
at least one main body housing at least one heating element which extends substantially over the length of the wiper; and
a wiper blade according to claim 1, the rib whereof is housed in the said main body.
